(19) United States
(12) Patent Application Publication
(10) Pub. No.: US 2015/0219487 A1
(43) Pub. Date: Aug. 6, 2015

(54) RAILWAY FREIGHT CAR ON-BOARD WEIGHING SYSTEM

(71) Applicant: Amstead Rail Company, Inc., Chicago, IL (US)

(72) Inventor: Dan Maraini, Broomall, PA (US)

(73) Assignee: Amstead Rail Company, Inc., Chicago, IL (US)

(21) Appl. No.: 14/169,784

(22) Filed: Jan. 31, 2014

(51) Int. Cl. G01G 19/04

(52) U.S. Cl. CPC G01G 19/042

(57) ABSTRACT

A railcar weight sensing system is provided. The system includes at least one transducer positioned on a railway car bolster or sideframe. Signals from the transducer are transmitted to a receiver.

### BACKGROUND OF THE INVENTION

The present invention relates to railcar weighing systems and, more particularly, to on board railcar weighing systems.

It is desirable to be able to obtain the weight of loading in a railway freight car or tank car. It is especially desirable to be able to obtain the weight of loading in a railway freight car or tank car on a real time basis, without need for the railcar to be in a specific location, such as a scale.

It is also desirable to be able to transmit a signal indicative of the weight of loading in the railcar or tank car to a bolster wherein such signal can be stored.

Accordingly, it is an object of the present invention to provide a method and apparatus for measuring the weight of loading in a railway freight car or tank car and to transmit a signal indicative of such weight to a receiver.

### SUMMARY OF THE INVENTION

This invention covers several embodiments of a system for measuring the static or dynamic load of a railway car. In one embodiment, displacement/strain type transducers are mounted symmetrically to the bolsters of the trucks supporting the railway car body. In this embodiment, the lateral and longitudinal load imbalances are measured, in addition to the weight of the railway car body. Wireless sensors are used to read and transmit the output of the transducers. The readings are sent to either a local receiver, or a remote location.

### BRIEF DESCRIPTION OF THE DRAWINGS

FIG. 1 is an illustration of a typical three-piece truck assembly consisting of a bolster, side frames, axles, spring groups, and side bearings.

FIG. 2 is an illustration of an embodiment of the invention with the sensors/transducers symmetrically mounted on the bolster of the railway car truck.

FIG. 3 is an illustration of a detail of the embodiment in FIG. 2 showing the transducer and sensing element.

FIG. 4 is an illustration of another embodiment of the invention with the sensors/transducers symmetrically mounted on the side frame of the railway car truck.

FIG. 5 is an illustration of a detail of the embodiment in FIG. 3 showing the transducer and sensor.

FIG. 6 is an illustration of an embodiment of the elastic element portion of the transducer.

FIG. 7 is a schematic of the data flow from transducers to a remote receiver.

### DETAILED DESCRIPTION OF THE INVENTION

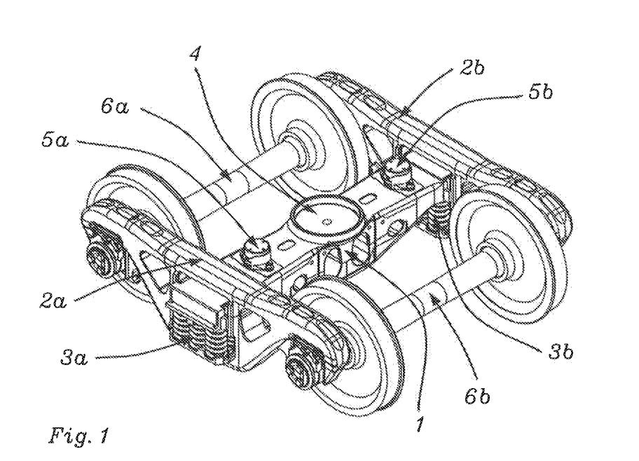

A general three piece truck system is shown in FIG. 1. This includes a bolster 1 which extends between the openings of two laterally spaced side frames 2a and 2b. The bolster 1 is supported at its ends with load spring groups 3a and 3b. The bolster 1 includes a center plate 4 and laterally spaced side bearings 5a and 5b for supporting the railway car body weight. Axle assemblies 6a and 6b extend laterally between the side frames 2a and 2b.

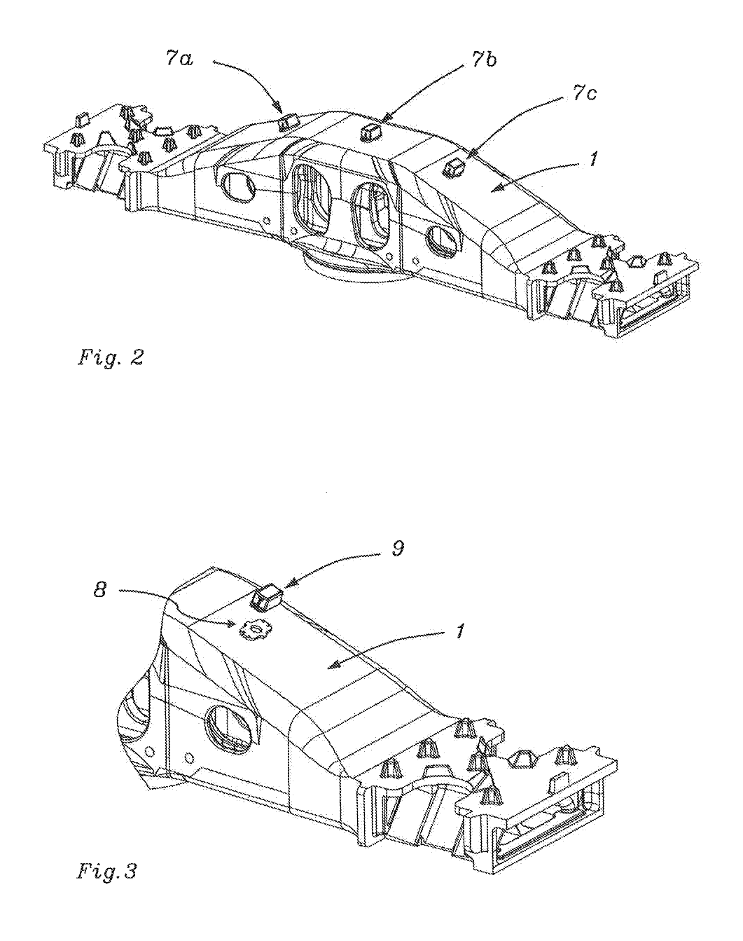

The first embodiment of the invention is shown in FIG. 2, including a three-piece truck bolster 1 and wireless strain/displacement sensors 7a-7c. The sensors 7a-7c are mounted to the bolster 1 in locations selected using analytical/numerical stress analysis techniques. Additionally, areas identified using computational techniques are verified using experimental stress analysis, which may include the use of strain gages and/or displacement transducers. Locations are also chosen such that hot-work from welding or similar techniques remains within accepted zones as specified by the Association for American Railroads (AAR). In the preferred arrangement, two sensors 7 are mounted to the diagonal tension member of the bolster 1 as shown in FIG. 1, although a variety of other mounting configurations are possible.

Each wireless strain/displacement sensor 7 includes a strain/displacement transducer 8 and wireless sensing unit 9 as shown in FIG. 3. In the preferred embodiment, the strain/displacement transducers 8 are rigidly attached to the bolster 1 using shielded metal arc welding (SMAW), although other techniques may be used including adhesives, fasteners, or similar methods. The use of a welded joint provides the most direct transfer of strain/displacement from the casting to the transducer 8 and minimizes errors associated with non-linearity, hysteresis, and zero-balance drift. The transducers 8 produce an electrical output that is proportional to the displacement/strain on the bolster 1 mounting surface. This principle applies to all other embodiments of the invention, and is used as an example in this case.

The wireless sensing unit 9 interfaces directly with the transducer 8 with the primary function of reading and digitizing the output signal from the transducer 8. In the preferred embodiment, the wireless sensing unit 9 contains a microprocessor unit with associated analog-to-digital (A/D) convertors and signal conditioning, a power source, and a communications unit in the form of a wireless transmitter/receiver. The wireless sensing unit 9 may also contain additional sensing elements including inertial, temperature, or pressure sensors. These additional sensors may be used for logic and decision making on the integrity of transducer 8 data. For example, transducer signals collected outside of the operating temperature limits of the transducer may be discarded using logic within the wireless sensing unit 9. The wireless sensing units 9 communicate with a local communications manager 15 which will be described hereafter.

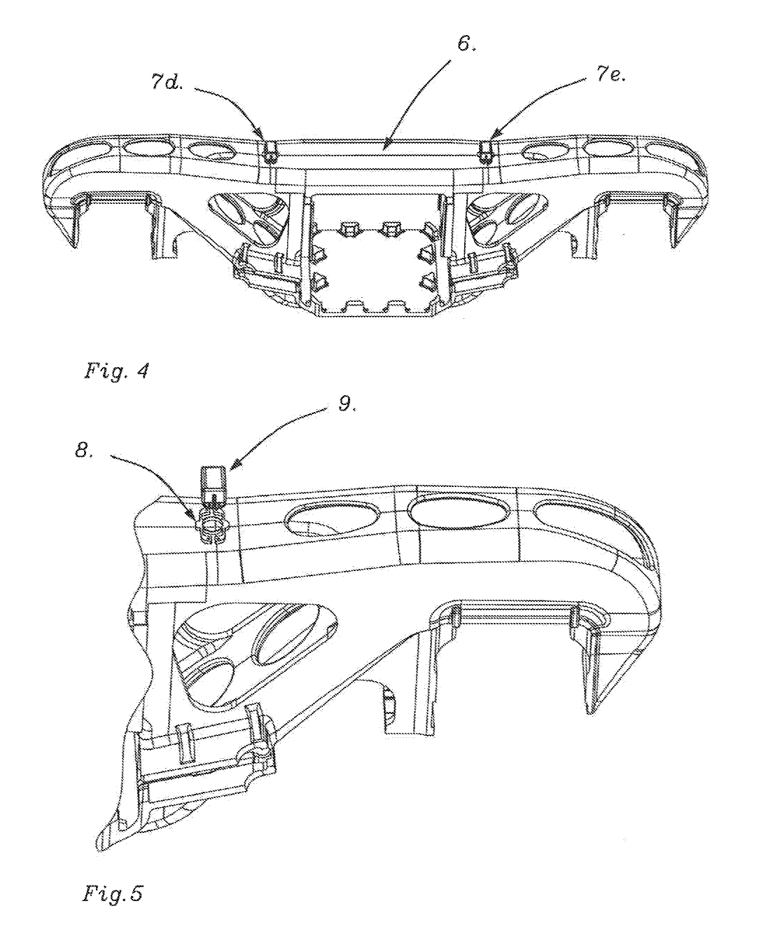

A second embodiment of the invention is shown in FIGS. 4 and 5, including a three-piece truck side frame 6, and laterally spaced wireless transducer assemblies 7d-7e, each consisting of a strain/displacement transducer 8 and wireless sensing unit 9. This embodiment operates on the same principles described for the first embodiment in FIG. 2, with the primary difference of wireless sensor 7 locations. These are the preferred embodiments of the invention, but wireless sensor 7 location and quantity is not limited to those discussed herein and are used as examples only. In the most general sense, sensors 7 can be located anywhere on the railway vehicle that exhibit changes in stress/strain/displacement in response to an applied load.

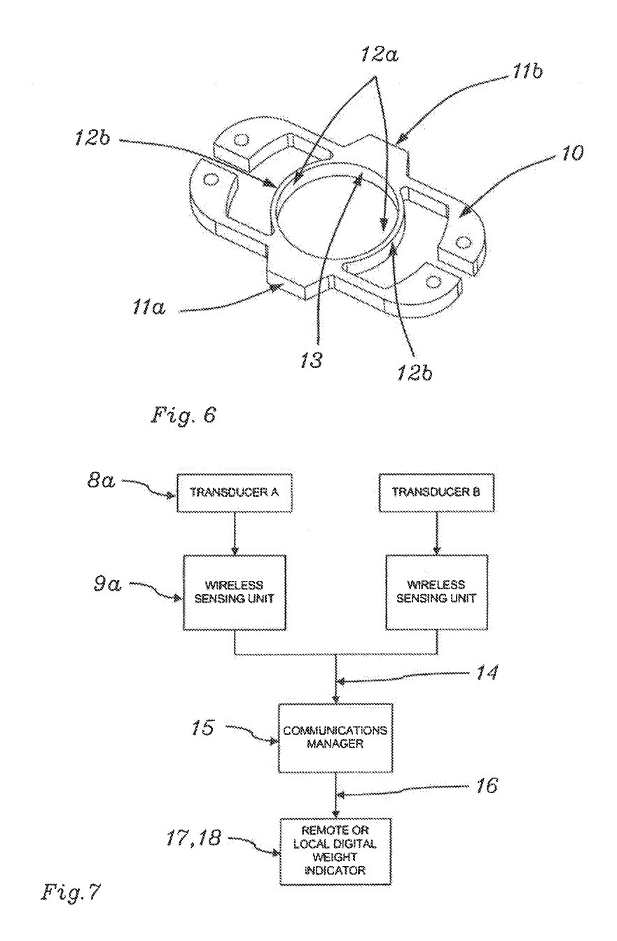

FIG. 6 illustrates a general overview of the displacement/strain transducer structure for example only. The transducer 8 includes an elastic element 10 (preferably stainless steel) with the primary purpose of transmitting displacement/strain from the tabs 11a-11b to a portion of the elastic element wherein strain gages 12a-12b are mounted. Secondly, the elastic element 10 is designed such that the input displacement/strain at the tabs 11a-11b is mechanically amplified in the location of the strain gages 12a-12b. In this embodiment, the elastic element 10 is designed for bending with the application of tensile or compressive strain/displacement on the tabs 11a-11b. This example utilizes four active strain gages in a Wheatstone bridge arrangement, although other elastic element geometries may include more active gages. The transducer 8 produces an electrical output signal that is proportional to both the applied input voltage and strain/displacement input at the tabs 11a-11b. Additionally, the transducer 8 includes a temperature detector 13, used to measure the elastic element 10 temperature in the location of the strain gages 12a-12b. In the preferred embodiment, the temperature detector 13 is of the form of a surface mount resistance temperature detector (RTD), although similar detectors may be substituted.

The preferred embodiment illustrated in FIG. 6 has been discussed, although other transducers may be used as long as they provide an electrical output that is proportional to the mounting surface strain/displacement. Examples include linear variable differential transformers (LVDT), vibrating wire transducers (VWT), and fiber Bragg grating strain sensors. The discussed principles of operation apply to any of the aforementioned transducer types.

FIG. 7 illustrates the preferred embodiment of the components of the present invention and their interaction. In this embodiment, two wireless strain/displacement sensors 7 are mounted to the bolsters 1 on the diagonal tension members as shown in FIG. 2. The output from laterally spaced transducers 8 on a single bolster 1 is sampled and conditioned by the wireless sensing unit 9. Conditioning includes amplifying the raw signal from the transducer 7, filtering the signal to remove noise, and averaging sets of individual data points to minimize sampling error. The analog-to-digital converter (A/D) converts the conditioned signal into digital form, with resolution at least ⅕ of the system accuracy. The digitized output is then sent wirelessly 14 to a local communications manager 15 (preferably mounted on the railway car body). The manager 15 sums the signals from each pair of sensors 7 and applies a calibration for each truck, using sealed parameters stored in memory in the manager 15. The calibrated output from each truck is summed and sent wirelessly 16 either to a local digital weight indicator 17, or remotely to a dedicated computer or workstation 18. Wireless transmission 16 from the manager 15 to the remote receiver 17-18 can be achieved using various methods, and will be discussed in more detail hereafter. In the preferred embodiment, data is transferred wirelessly 16 via Bluetooth to a dedicated digital weight indicator 17.

As noted previously, the preferred embodiment utilizes sealed calibration parameters in the communications manager 15 to convert the digital sensor data into weight readings. In the present invention, sensors 7 are mounted to structurally supportive areas of the railway car that have been analytically and experimentally proven to react with a high degree of repeatability to an applied load. However, it is recognized that there is an intrinsic variation in the relationship between applied load and strain/displacement that warrants unique calibration of each component. In the preferred embodiment, this necessitates calibrating individual truck assemblies. Calibration of an individual truck assembly can be achieved using a dedicated hydraulic load frame for applying loads to the center plate 4 and side bearings 5a-5b of the bolster 1, while the truck is supported on rails through the axle assemblies 6a-6b. The preferred method is the adoption of industry accepted calibration routines, such as ASTM E74-Standard Practice of Calibration of Force-Measuring Instruments for Verifying the Force Indication of Testing Machines. In this preferred method, at least 5 ascending and descending calibration points are used and repeated at least 3 times. The use of such calibration practices ensures the highest degree of accuracy possible in the weight readings for a given truck assembly. By calibrating the truck systems before assembling the railway car, the system will thus measure the railway car body weight, as opposed to the gross rail load (GRL). Alternative methods, including calibration in the field with 1 or 2 calibration points will have significantly lower statistical certainty. However, simplified field calibrations may be used in cases where the highest degree of accuracy is not required. In commercial weighing applications used for custody transfer, evaluation in accordance with a National Type Evaluation Program (NTEP) may be necessary, which requires both laboratory and field verification testing.

The most basic form of transducer data processing has been described with reference to FIG. 7. It is generally assumed that the methods described are used under static or quasi-static conditions, both of which assume inertial effects of the railway vehicle are negligible. The preferred method for weighing a railway car requires an un-coupled condition, on level track, with the car completely at rest in accordance with the AAR Scales Handbook. However, there are instances where weight readings may be needed when the car is out-of-level or in motion. In these cases, the degree of car motion or out-of-level conditions can be assessed using the aforementioned inertial sensors within the wireless sensing unit 9 or similar sensors in the communications manager 15. Logic can thus be applied to make decisions regarding the accuracy of the sensor data based on the inertial measurements. For example, an inertial sensor may be used to indicate a rail grade of 5%, and subsequently inhibit the output of sensor readings because they have been deemed inaccurate for the given conditions. Alternatively, correction algorithms could be used to adjust the weight readings based on the degree of out-of-level or motion. Both examples provide a robust weighing solution that is relatively insensitive to conditions.

As static conditions are generally assumed with respect to the motion of the railway car, static environmental conditions are also generally assumed and preferred. However, it is commonly accepted that strain gage based transducers will exhibit some degree of zero-output shift with temperature change. In the preferred embodiment, a temperature detector 13 within the transducer 8 is sampled with each transducer reading in order to apply correction algorithms in the wireless sensing unit 9. In the simplest form, correction algorithms utilize first-order linear relationships between transducer 8 output and temperature, although higher order fitting may be necessary in some cases. Similar approaches could be used for correction for elevation, or correction of thermal output for different transducer types described previously. The highest degree of correction is achieved by calibrating the entire truck assembly (with sensors) in a thermal chamber or similar fixture. In the preferred embodiment, temperature correction provides the desired system accuracy (say 1% of full-scale) from −10 to 40° C., in accordance with NCWM Publication 14 and NIST Handbook 44.

Both static and weigh-in-motion type weight measurement have been described in previous sections. Additionally, transient forces occurring at the wheel-rail interface are transferred from the axle assemblies 6a-6b into the side frames 2a-2b, through the spring group 3a-3b, and into the bolster 1 during service. Both embodiments of the invention (FIGS. 2 and 3) incorporate strain/displacement sensors 7 on the side frames 2a-2b and/or bolster 1. Each embodiment therefore possesses some level of indirect force measurement at the wheel-rail interface. For example, a wheel with a surface defect on the tread in the form of a skid flat may induce periodic transient forces into the truck assembly, which can be measured with the said sensors 7. Such measurements are comparable to Wheel Impact Load Detectors (WILD), with the added benefit of being incorporated into the railway car. Additionally, forces induced into the truck assembly due to curving, instabilities, or similar conditions could be measured with the sensors 7.

As noted above, the wireless sensing units 9 transmit and receive data with a communications manager 15 mounted locally on the railway vehicle car body. This short range allows for the use of low-power radios conforming to standards such as IEEE802.15.4, for operation in the 2.4 GHz license-free band. In the preferred embodiment, the sensing units 9 are capable of being wireless routers, communicating with all other sensing units 9 for a redundant communication path to the manager 15. The manager 15 also continuously monitors and optimizes the network, dynamically changing data paths, and adjusting when sensing units 9 talk, listen, or sleep.

Additionally, the preferred embodiment provides end-to-end data security with 128 bit AES-based encryption, or similar methods common to the art. Similar low-power wireless networks can be employed, and data transmission is not limited to the methods discussed herein.

In the preferred embodiment, the communications manager 15 includes a computation element such as a micro-controller, memory, a stand-alone power supply, and sensors. Sensors may include ambient temperature, barometric pressure, proximity, or inertial sensors. Additionally, the manager 15 incorporates several communication methods including the aforementioned wireless sensor network, cellular (GSM/GPRS), satellite, and Bluetooth or WiFi for local communications. The manager 15 may also incorporate a wireless sensing unit 9 for creating a network of managers 15 along the train. With an additional manager 15 in the locomotive or the like, data from all aforementioned sensors can be monitored in the locomotive. Various methods can be used for communications along the train.

The manager 15 also may include a location measurement means such as a global positioning system (OPS). The positioning system can be used to determine railway car speed and location. Both speed and location can be used within algorithms to adjust wireless sensing unit 9 sampling rates, or inhibit data output all-together. For example, the weight of the railway car may not be of interest when being stored in a yard, so the position information could be used to inhibit the sampling and output of weight readings, thus preserving energy on both the communications manager 15 and wireless sensing units 9. Alternatively, weight readings may be needed every minute while the railway car is being loaded, so it is necessary for the manager 15 to be able to adjust sensor 9 sampling rates based on a combination of parameters and user inputs. In the preferred embodiment, the end user can adjust the sampling rate from a local digital weight indicator 17 as desired, although other autonomous methods may be needed in different environments.

It has been previously noted that the wireless strain/displacement sensors 7 can be used to measure dynamic forces at the rail/wheel interface. When combined with the aforementioned inertial sensor within the manager 15 or wireless sensing unit 9, an added level confidence is achieved regarding the reported state of the truck system. For example, periodic lateral forces in the bolster 1 may be detected by the sensors 7, and the associated car body response measured with an inertial sensor may be used to corroborate the event. The relationship between wheel/axle inputs and car body response can be readily determined with both computational and empirical techniques. This information can be used to create transfer functions within the manager 15 or wireless sensing unit 9 to accurately predict inputs.

What is claimed is:

1. A system for measuring the load of a railway car comprising:
a railway car body supported on railway wheels, axles and a plurality of trucks,
each truck comprised of a bolster and two sideframes,
a plurality of transducers mounted to
the bolster or the sideframes for measuring the weight supported by the railway car body,
one or more sensors associated with the transducers for the acquisition, processing, and transmission of processed data from the transducers,
a receiver for communication with the sensors and transmission of the processed data indicative of the weight supported by the railway car body.

2. The system in claim 1, wherein the said transducer is a strain type transducer.

3. The system in claim 2, wherein the transducer includes an elastic element that is mechanically joined to one or more of the bolster or the sideframes.

4. The system in claim 2, wherein the transducer includes a plurality of strain gages.

5. The system in claim 3, wherein the elastic element mechanically multiplies an input displacement detected at the strain gages.

6. The system in claim 4, wherein the strain gages are arranged in one or more Wheatstone bridge circuits.

7. The system in claim 1, wherein the transducers are mounted to a predetermined location on the bolster or the sideframes using a method comprised of:
a step of stress analysis using analytical or numerical techniques, wherein typical loads are simulated on the bolster or the sideframes and transducer locations are selected based on stress response;
a step of experimental stress analysis wherein the railway car body or bolster or sideframe are instrumented with appropriate transducers for the verification of computed stress from the stress analysis.

8. The system in claim 1, wherein the transducers are mounted symmetrically along the lateral or longitudinal direction of the railway car for determining static load imbalances between the wheels, axles, or trucks.

9. The system in claim 1, wherein each sensor is comprised of:
a computational element for collecting transducer readings;
a memory storage element;
a wireless transceiver for sending and receiving data,
a temperature detector for measuring the temperature at the mounting location of the transducers;
a motion detector for the indication of motion of the railway car;
an inertial sensor for the detection of static and dynamic translational and rotational motion of the bolster and the sideframes;

10. The system in claim 9, wherein the computational element is used to control the sampling of the transducers and for performing analysis on the transducer readings.

11. The system in claim 9, wherein the memory storage element is used to store the transducer, inertial sensor, or motion detector readings.

12. The system in claim 9, wherein the wireless transceiver communicates with one or more of the sensors, all of which communicate with the receiver, so that multiple communication paths are open for data transmission.

13. The system in claim 9, wherein the motion detector is used to determine if the railway vehicle is in motion and to change the transducer readings analysis for static or dynamic conditions.

14. The system in claim 9, wherein the computational element is used to compute the rate of the readings taken from the temperature detector.

15. The system in claim 9, wherein the computational element is used to adjust the transducer readings based on the rates and temperature readings.

16. The system in claim 1, wherein the sensors transmit synchronized transducer to the receiver.

17. The system in claim 1, wherein the receiver comprises:
a data control unit for receiving readings from one or more of the sensors;
a communication element for transmitting data to a remote location,
a computational element for analyzing the data received from one or more of the sensors;
a detector for determining the speed of the railway car; and
a positioning element for determining the location of the railway car.

18. The system in claim 17, wherein the data control unit programs computational element on the sensors to control the sampling of the transducers and the rate of which readings shall be transmitted to the receiver.

19. The system in claim 1, wherein the transducers are used to measure transient forces occurring at a rail and wheel interface.

20. A system for measuring the load of a railway car comprising:
a railway car body supported on railway wheels, two axles and a plurality of trucks,
each truck comprised of a bolster and two sideframes,
a plurality of strain transducers mounted to
the bolster or the sideframes for measuring the weight supported by the railway car body,
one or more sensors associated with the transducers for the acquisition, processing, and transmission of processed data from the transducers,
a transceiver for communication with the sensors and transmission of the processed data indicative of the weight supported by the railway car body,
wherein each sensor is comprised of:
a computational element for collecting transducer readings;
a memory storage element; and
a wireless transceiver for sending and receiving data.
